(19) United States
(12) Patent Application Publication
(10) Pub. No.: US 2014/0232511 A1
(43) Pub. Date: Aug. 21, 2014

(54) THERMAL OVERLOAD PROTECTION APPARATUS

(71) Applicants: Rainer Durth, Horn-Bad Meinberg (DE); Thomas Meyer, Ottenstein (DE)

(72) Inventors: Rainer Durth, Horn-Bad Meinberg (DE); Thomas Meyer, Ottenstein (DE)

(73) Assignee: PHOENIX CONTACT GMBH & CO. KG, Blomberg (DE)

(21) Appl. No.: 14/236,851

(22) PCT Filed: Aug. 3, 2012
(86) PCT No.: PCT/EP2012/065231

§ 371 Date: May 8, 2014

(30) Foreign Application Priority Data
Aug. 3, 2011 (DE) 10 2011 052 390.1

(51) Int. Cl. H01H 37/76

(52) U.S. Cl. CPC H01H 37/764
USPC 337/180

(57) ABSTRACT

Systems and methods are disclosed relating to a thermal overload protection apparatus and processes for protecting an electrical component. In one illustrative implementation, a thermal overload protection apparatus includes a switching element for short-circuiting connections of the component or for isolating an electrically conductive connection between at least one of the connections and a current-carrying element of the overload protection apparatus, an actuator for switching the switching element into a corresponding short-circuiting position or isolating position, and a tripping element that thermosensitively trips the actuator apparatus. and is formed as a separating element. According to further implementations, various other arrangements and methods for producing devices are disclosed.

The invention relates to a thermal overload apparatus for protecting an electrical component, which thermal overload protection apparatus has a switching element for short-circuiting connections of the component or for disconnecting an electrically conductive connection between at least one of the connections and one current-carrying element of the overload apparatus, an actuator apparatus for displacing the switching element into a corresponding short-circuiting position or isolating position, and a tripping element which thermosensitively trips the actuator apparatus and is formed as a separating element. The invention furthermore relates to a method for producing a composite comprising a switching element, a base element and a separating element for a corresponding overload protection apparatus.

Such an overload apparatus is known, for example, from the published patent application DE 10 2008 022 794 A1. This document describes a thermal overload protection apparatus having a short-circuiting device including a spring-biased shorting jumper for short-circuiting electrodes of a surge protection arrester and a fusible element that trips the overload protection apparatus. In addition to this embodiment as an overload protection apparatus having a switching element of a short-circuiting device, an overload protection apparatus having a corresponding switching element of an isolating device is also conceivable.

Overloading electronic components can cause that they operate outside of a rated operating range. For example, power consumption caused by reduced insulation strength of the component results in increased heating of the damaged component. If heating of the component above an admissible threshold is not prevented, this can result, for example, in damage to surrounding materials, development of flue gases, or in fire hazard.

These dangers also arise in the case of an arrangement of components arranged on a conductor track carrier such as, for example, surface-mountable components. For constructing such an arrangement, the conductor track carrier (the circuit board/board) is assembled with corresponding components, in most cases by automatic units, and soldered. Due to the dense placement, the available space is often very limited. At the same time, local temperatures occur which come at least close to the tripping temperature of the separating element.

It is an object of the invention to propose a thermal overload protection apparatus which needs little space, responds reliably to thermal overload and short-circuits or isolates, and which, despite the resulting temperatures, can easily be integrated in a mounting process of a mounting, in particular surface mounting, of components on a conductor track carrier. Furthermore, it is an object of the invention to propose a corresponding production method.

This object is achieved according to the invention by the features of the independent claims. Advantageous configurations of the invention are specified in the sub-claims.

The overload protection apparatus according to the invention has a base element to which the separating element is connected, wherein the base element can be soldered by means of a standard soldered joint on its side that faces away from the separating element. Through this base element, an intermediate element is formed between the thermosensitive separating element and a solder point of the overload protection apparatus, via which the heat transport to the separating element takes place in the case of a tripping event. Through the heat capacity of the base element, a heat buffer is created that enables soldering the overload protection apparatus by a short-term soldering process using standard solder on the one side of the base element without damaging the separating element.

At this point, it should be noted that the term “isolating” refers to an electrically conductive connection whereas the term “separating” and “separating element” refers to mechanically separating the base element that can be soldered by means of a standard soldered joint from a remaining portion of the overload protection apparatus for tripping purposes. Separating can also be isolating at the same time, but—in particular when using the switching element for short-circuiting—it does not have to be.

The component preferably is a component that can be mounted or is mounted with its connections onto a conductor track carrier having conductor tracks. The current-carrying element of the electrically conductive connection in an electrical switching element configured as an isolating device is in particular one of the conductor tracks or a current-carrying element mounted on the conductor track carrier and connected to one of the conductor tracks. The electrically conductive connection is a connection for wiring the component. Short-circuiting is in particular short-circuiting via at least one of the conductor tracks.

Advantageously, it is provided that the separating element is configured as a fusible element that trips by melting. The melting temperature of the fusible element determines the tripping temperature, which therefore can be set via material selection.

According to a preferred configuration of the invention it is provided that the fusible element that trips by means of melting has a melting point that is lower than that of the solder of the standard soldered joint. The fusible element has as an active material, for example, a functional solder or a fusible plastic, each of which has a significantly lower melting point than standard solder (thus, the solder of the standard soldered joint). Here, a significantly lower melting point is to be understood as a melting point that is lower by 20 K or by more than 20 K (≧20 K or ≧20° C.).

Compared to a standard solder, the fusible plastic furthermore shows a softer transition of its consistency at the melting point. This has the advantage that a separating element from a fusible plastic remains at its original location even in the case of tripping, and by tripping only changes its shape in such a manner that the short-circuiting device is able to short-circuit the component.

According to another preferred configuration of the invention it is provided that the component is mechanically connected to the switching element via the non-tripped separating element. In particular, the electrically conductive base element is also connected in an electrically conductive manner to the switching element via the non-tripped separating element. If the switching element is configured as an isolating device for isolating an electrically conductive connection of at least one of the connections to the current-carrying element, the fusible element preferably is a soldered joint within the electrically conductive connection (to be isolated). Mechanically separating the base element and the switching element is then directly coupled with isolating the electrically conductive connection.

Advantageously, it is provided that the actuator apparatus, for its activation from an inactive state in which the switching element cannot be displaced by the actuator apparatus, not even by tripping by means of the separating element, can be switched over into a tripable state in which the switching element can be displaced by the actuator apparatus that can be tripped by means of the separating element. The terms “inactive” and “tripable” thus mean in this context that only the actuator apparatus activated by switching over provides the force required for short-circuiting or isolating, and the non-activated, thus inactive actuator apparatus, even upon tripping by means of the separating element, provides no force or a force that is not sufficient for short-circuiting or disconnecting. Such an overload protection apparatus can be mounted without the danger of tripping, even by means of a mounting process associated with high temperatures such as, for example, soldering. This enables that activating is possible only after reaching a non-critical temperature or at a freely selectable time. This time can be a time in particular after completion of the mounting of the overload protection apparatus and/or the electrical component.

According to a preferred configuration of the invention it is provided that the actuator apparatus is an actuator apparatus that can be switched over by manually changing the outer shape of the actuator apparatus or the arrangement of the actuator apparatus relative to the switching element. Switching over thus is a manual switching over by changing the outer shape of the actuator apparatus or by changing the arrangement of the actuator apparatus relative to the switching element. The activation can be performed directly on the overload protection apparatus. The time of activation is freely selectable by a user.

According to an advantageous configuration of the invention it is provided that the actuator apparatus has at least one spring element, in particular, that it is a spring element. By pre-tensioning the spring element, the actuator apparatus is switched over.

It is in particular provided here that the spring element is a snap dome or has a snap dome. Snap domes are spring elements that operate according to the clicker principle. A clicker is a spring element that is made from a strip of spring steel. Said steel is stamped such that it has a stable and a metastable state. By applying force in the stable state, it is bent until it suddenly springs back into the metastable state due to buckling. In most cases, the spring element of the clicker has a dome-like or dome-section-like region that is created by stamping. In this configuration of the invention, the two states are preferably used for generating a relaxed and a pretensioned state of the spring element. Switching over in this context is switching from the relaxed state to the pretensioned state.

Alternatively or additionally, it is advantageously provided that the actuator apparatus comprises as active material an intumescent material and/or a shape memory material and/or a material that changes its shape chemically.

It is in particular provided that in the switched-over state, the actuator apparatus is an actuator apparatus that is mechanically pretensioned by means of a latching mechanism at the switching element. Parts of the actuator apparatus and/or the switching element thus are latched with each other when the actuator apparatus is switched over, or are otherwise operatively engaged with one another so as to pretension the actuator apparatus.

Alternatively or additionally, it is advantageously provided that the actuator apparatus is a device that can be switched over (and thus activated) by means of mutual displacement of parts or regions of the actuator apparatus. If the actuator apparatus has a spring element that operates according to the clicker principle (for example a snap dome), said displacement is a buckling of a region of this spring element.

According to a refinement of the invention it is provided that the switching element and the actuator apparatus are formed integrally, or comprise at least one part that is formed integrally. This reduces the number of required parts and defines a clear connection between the switching element and the actuator apparatus.

According to a preferred embodiment of the invention it is provided that the overload protection apparatus is an overload apparatus that can be separated from the component. The component and the overload protection apparatus thus can be manipulated independently of each other—at least in principle. This degree of freedom simplifies in particular the mounting of the component and/or the overload protection apparatus.

The invention further relates to an arrangement comprising a conductor track carrier, at least one component arranged thereon and at least one aforementioned overload protection apparatus, wherein the base element is soldered by means of the standard soldered joint to a conductor track of the conductor track carrier, which conductor track, in turn, is directly connected to a connection of the component. The component preferably is a surge protection arrester, in particular semiconductor-based (suppressor diode, varistor, etc.), or a gas-filled surge arrestor or a resistor.

In particular, said component is a surface-mounted component (SMD component), which preferably is mounted on the conductor tracks of the conductor track carrier by means of a reflow soldering process.

According to a preferred embodiment of the invention it is provided that the switching element and/or the actuator apparatus of the overload protection apparatus is supported via the separating element (thus indirectly) on a conductor track of the conductor track carrier, which conductor track is directly connected to a connection of the component. Alternatively or additionally, it is in particular provided that the switching element and/or the actuator apparatus of the overload protection apparatus is directly supported on at least one conductor track.

The invention furthermore relates to a method for producing a composite comprising a switching element, a base element for soldering the composite, and a separating element that is arranged between the switching element and the base element and connects them. Said method includes the following steps: (i) providing the switching element with an extension of the one end region, (ii) folding the extension next to the end region, (iii) introducing a fusible element between the end region and the extension, and (iv) removing the edge created during folding, wherein the remain portion of the extension forms the base element. The switching element and the base element are produced from the same part, preferably a stamped and bent part.

According to a preferred embodiment of the invention it is provided that the extension or the base element is trough-shaped. The trough-shaped configuration prevents the fusible element, which preferably is a functional solder, from flowing away.

The invention is explained below in greater detail with reference to the attached drawing and by means of exemplary embodiments.

In the figures:

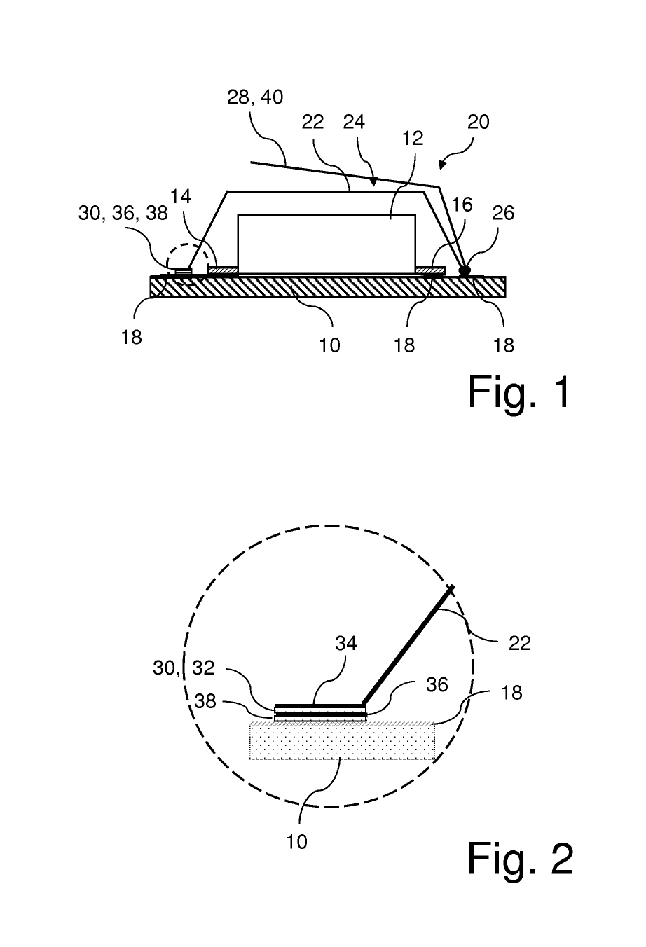

FIG. 1 shows an electronic component and a thermal overload protection apparatus in the non-activated operating state according to a first embodiment of the invention,

FIG. 2 shows a tripping composite of the overload protection apparatus composed of a switching element, a base element and separating element that is arranged between the switching element and the base element and connects them,

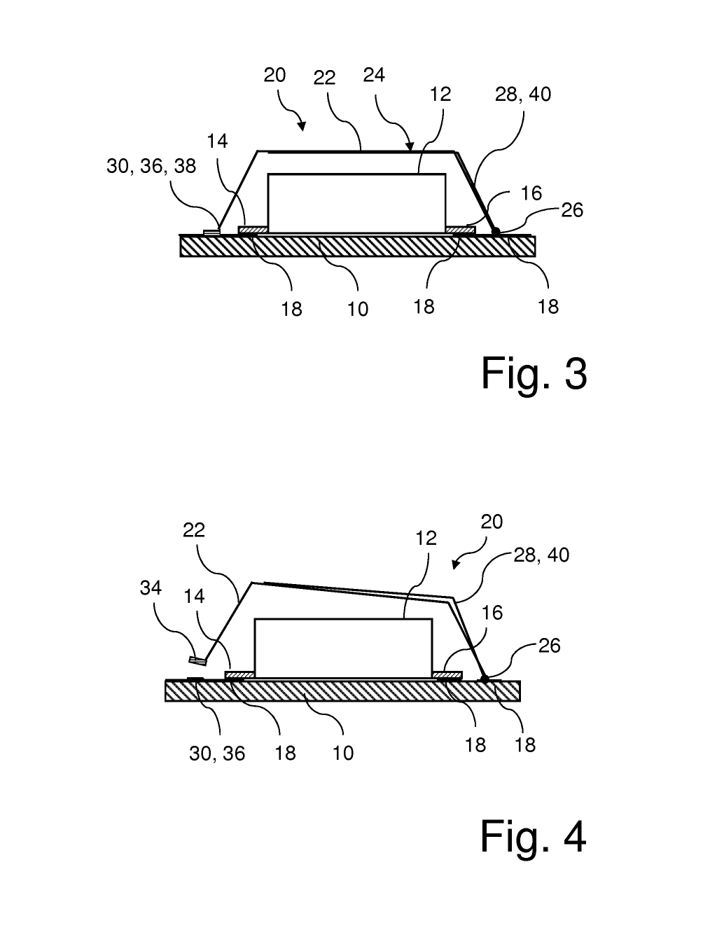

FIG. 3 shows the component and the thermal overload protection apparatus of FIG. 1 in the activated operating state,

FIG. 4 shows the component and the thermal overload protection apparatus of the FIGS. 1 and 3 in the tripped operating state,

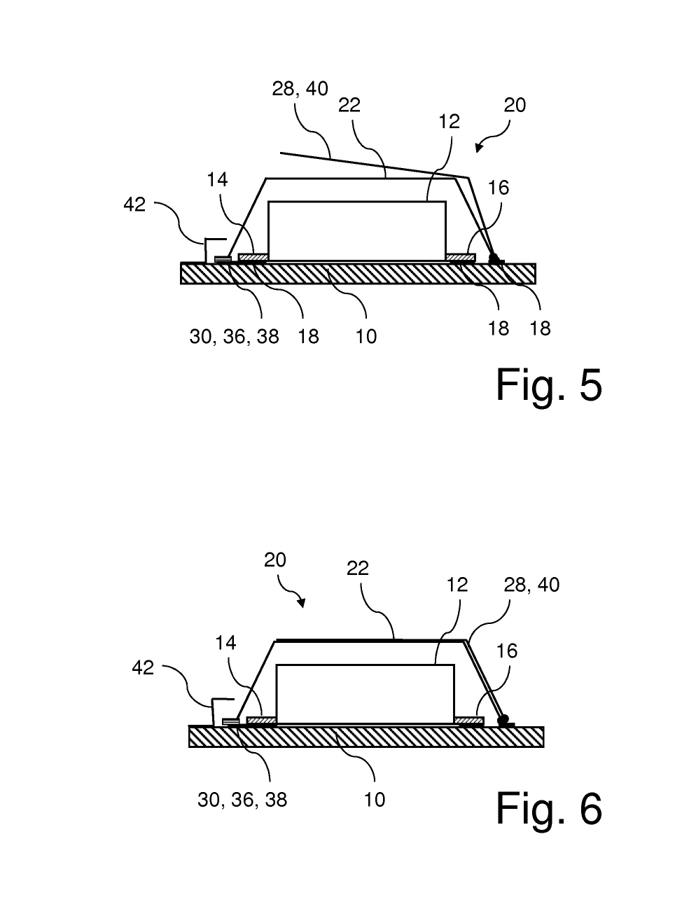

FIG. 5 shows an electronic component and a thermal overload protection apparatus in the non-active operating state according to a second embodiment of the invention,

FIG. 6 shows the component and the thermal overload protection apparatus of FIG. 5 in the activated operating state,

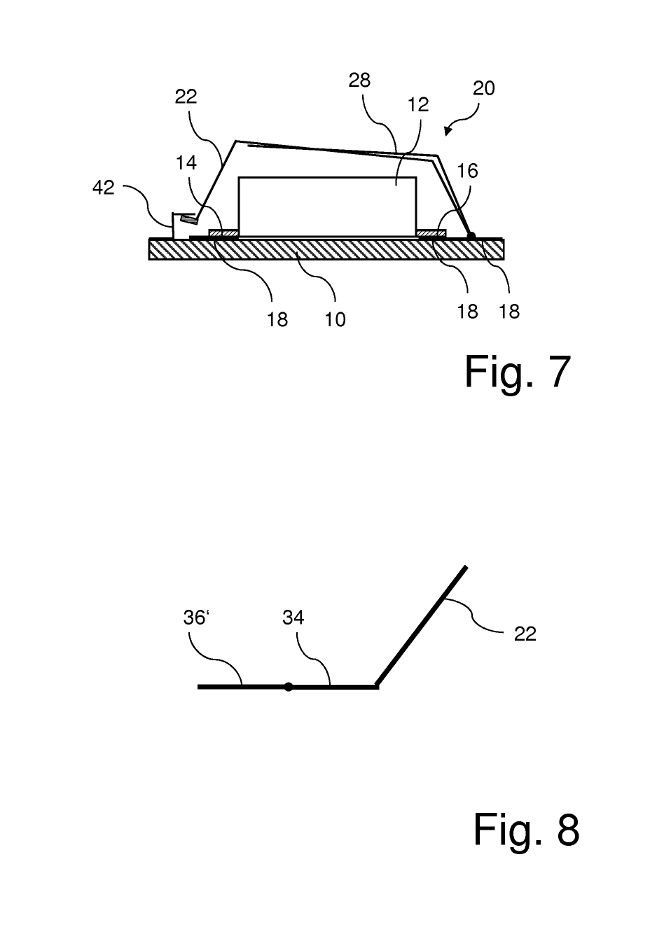

FIG. 7 shows the component and the thermal overload protection apparatus of the FIGS. 5 and 6 in the tripped operating state,

FIG. 8 shows the initial situation during the production of the composite of FIG. 2,

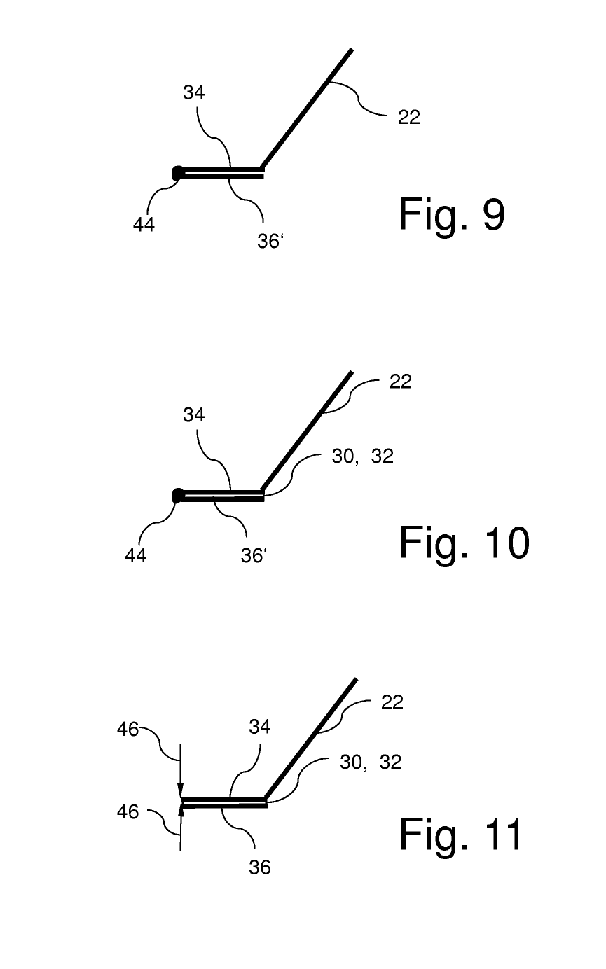

FIG. 9 shows a first intermediate result during the production of the composite of FIG. 2,

FIG. 10 shows a first intermediate result during the production of the composite of FIG. 2, and

FIG. 11 shows the final result during the production of the composite of FIG. 2.

FIG. 1 shows a schematic illustration of an electrical component 12 arranged on a conductor track carrier 10. The electrical component 12 is in particular formed as an electronic component which is soldered with its electrical connections 14, 16 on the conductor tracks 18 of the conductor track carrier 10 by means of standard soldered joints (not shown here).

Furthermore, an overload protection apparatus 20 associated with the component 12 is shown.

The overload protection apparatus 20 comprises a switching element 22 for isolating an electrically conductive connection 24 between a current-carrying element 16 of the overload protection apparatus 20 and one of the connections 14 of the electrical component 20. The current-carrying element 26 is likewise soldered by means of a standard soldered joint (not shown) to one of the conductor tracks 18. Furthermore, the overload apparatus 20 comprises an actuator apparatus 28 and a tripping element that thermosensitively trips the actuator apparatus 28 and is configured as a separating element 30. In the example of the Figures, this separating element 30 is configured as a fusible element 32 between an end region of the switching element 22 and a base element 36, as explicitly shown in FIG. 2. The production process of the composite comprising the end region 34 of the switching element, the fusible element 32 and the base element 36 created from an extension 36′ of the end region 34 is shown in the FIGS. 8 to 11.

FIG. 2 shows in detail the portion of the overload protection apparatus 20 marked by means of the dashed circle. In this embodiment, the base element 36 is formed as a sheet metal or a stamped and bent part that carries on its upper side the fusible element 32, and on its (lower) side facing away from the fusible element 32, it is soldered by means of a standard soldered joint 38 onto one of the conductor tracks 18. The fusible element 32 shown is a soldered joint, the solder of which melts at a considerably lower temperature (for example 20° C. lower) than the standard solder used here for soldering the component 12 and the overload protection apparatus 20 onto the conductor track carrier 10.

Since the standard soldered joint 38, the base element 36 and the separating element 30 that is formed as a soldered joint are electrically conductive, the conductor track 18, which is directly connected to the one connection 14, is connected in the non-tripped state of the separating element 30 in an electrically conductive manner to the switching element 22, and is connected to the further conductor track 18 via the current-carrying element 26. Thus, the conductive connection 24 is established. Due the displacement/deformation of the switching element 30 tripped by the separating element 30 and carried out by the actuator apparatus 28, it is possible to disconnect the conductive connection 24 and to de-energize the component 12.

FIG. 1 shows the overload protection apparatus 20 with switching element 22 and actuator apparatus 28 in an inactive state in which the switching element 22 cannot be displaced or is not displaced, not even by tripping by means of the separating element 30, by the actuator apparatus 28 that is formed as a spring element because in this state, the actuator apparatus 28 does not exert force on the switching element 22.

FIG. 3 shows the overload protection apparatus 20 with the switching element 22 and the actuator apparatus 28 after switching into the tripable state in which the switching element 22 can be displaced by the actuator apparatus 28 which can be tripped by means of the separating element 30. By means of a force that is to be applied manually, the actuator apparatus 28 that is formed as a spring element 40 is bent/pivoted with respect to the switching element 22 in such a manner that the actuator apparatus 28 is mechanically pretensioned at the switching element 22 by means of a latching mechanism (not shown) and thus is switched over into the tripable state.

FIG. 4 indicates the disconnected connection of the base element 36 and the switching element 22. After switching over into the tripable state (FIG. 3) in which the switching element 22 can be displaced by the actuator apparatus 28 that can be tripped by means of the separating element 30, and subsequent tripping by the separating element 30, the pretensioned spring element 40 of the actuator apparatus 28 pulls the one end region 34 away from the base element 36 (isolating position) so that the electrically conductive connection 24 is isolated.

This results in the following advantages: in the mounting state of the overload protection apparatus 20, the latter is force-free. Mounting on the carrier 10 can take place through simple placement, in particular by means of an automatic placement machine. For the soldering process, no fixation or holding down is required. Subsequent to the mounting/the soldering process, the apparatus can be activated by mutual latching (or buckling) of switching element 22 and spring element 40. Since the base element 36 can be soldered onto the conductor track 18 using a standard solder, the overload protection apparatus 20 can be soldered together with the components 12 by a machine.

In the operating state, the switch formed on the carrier 10 by the spring element 40 and the contacting point with the base element 36 and the fusible element 32 is closed. Inadmissible heating of the component 12 via the activation temperature results in activation of the apparatus 20 which is in the tripable state. Upon exceeding the activation temperature (solder melting temperature of the fusible element formed as solder, not the higher melting temperature of the standard solder), the spring tension of the spring element 40 causes the switch formed in this manner to open, and the component 12 is therefore transferred into a secure state.

The FIGS. 5 to 7 show an arrangement in which the overload protection apparatus 20 short-circuits the connections 14, 16 in the case of thermal overload by means of the switching element 22 that is formed as a shorting jumper. The electrically conductive switching element 22 is arranged together with the component 12. For this, the switching element 22 is likewise secured on the carrier 10. Together with another current-carrying element 42 that is secured on the carrier 10 and is formed as short-circuiting metal, the end region 34 of the switching element 22 forms an electrical switch.

FIG. 5 shows the overload protection apparatus 20 with switching element 22 and actuator apparatus 28 in an inactive state in which the switching element 22 cannot be displaced or is not displaced by the actuator apparatus 28, not even by tripping by means of the separating element 30, because in this state, the actuator apparatus 28 does not exert force on the switching element 22. Here too, the separating element 30 is configured as fusible element 32, for example as fusible plastic.

FIG. 6 shows the overload protection apparatus 20 with the switching element 22 and the actuator apparatus 28 after switching over into the tripable state in which the switching element 22 can be displaced by the actuator apparatus 28 which can be tripped by means of the separating element 30. By means of force to be applied manually, the actuator apparatus 28 is bent/pivoted with respect to the switching element 22 in such a manner that the actuator apparatus 28 is mechanically pretensioned at the switching element 22 by means of a latching mechanism (not shown) and thus is switched over into the tripable state. In this embodiment, the actuator apparatus 28 is formed as a spring element 40.

FIG. 7 shows the component 12 that is short-circuited by means of the switching element 22 formed as a shorting jumper after tripping by the separating element 30. The pretensioned spring element 40 of the actuator apparatus 28 pulls the one end region 34 away from the base element 36 and lifts it so far that the short circuit is effected via the hook-shaped other current-carrying element 42 and corresponding conductor tracks 18 (short-circuiting position).

This results in the following advantages: in the mounting state of the overload protection apparatus 20, the latter is force-free. Mounting on the carrier 10 can take place through simple placement, in particular by means of an automatic placement machine. For the soldering process, no fixation or holding down is required. Subsequent to the mounting/the soldering process, the apparatus can be activated by mutual latching (or buckling) of switching element 22 and spring element 40. Since the base element 36 can be soldered onto the conductor track 18 using a standard solder, the overload protection apparatus 20 can be soldered together with the components 12 by a machine.

In the operating state, the switch formed on the carrier 10 by the spring element 40 and the contacting point with the base element 36 and the fusible element 32 is open. Inadmissible heating of the component 12 via the activation temperature results in activation of the overload protection apparatus 20 which is in the tripable state. Upon exceeding the activation temperature (solder melting temperature of the fusible element formed as solder), the spring tension of the spring element 40 causes the switch formed in this manner to close, and the component 12 is therefore transferred into a secure state.

The FIGS. 8 to 11 outline a method for producing a composite comprising the switching element 22, the base element 36 and the separating element 30 that is arranged between the switching element 22 and the base element 36 and connects them. This composite is already shown in FIG. 2. The production method includes the following steps:

providing the switching element 22 with an extension 36′ of the one end region 34 (FIG. 8),

folding the extension 36′ next to or below the end region 34 (FIG. 9),

introducing the fusible element 32 in the form of a functional solder between the end region 34 and the extension 36′ (FIG. 10) and

removing the edge 44 (indicated by the arrows 46) created during folding, wherein the remaining portion of the extension 36′, which remaining portion is no longer connected to the end region 34 in a form-fitting manner, forms the base element 36 (FIG. 11).

Removing the edge 44 can be carried out, for example, by means of a cutting process or another separating process (indicated by arrows 46). The result is the composite shown in FIG. 2. Said composite is part of the overload protection apparatus 20.

Optionally, the extension 36′ or the base element 36 is trough-shaped. The trough-shaped configuration of the base element 36 prevents the fusible element 32 (functional solder) from flowing away when the composite or the overload protection apparatus 20 later is soldered by means of standard solder to the lower side of the base element 36.

### REFERENCE LIST

Conductor track carrier 10
Component 12
Connection 14
Connection 16
Conductor track 18
Overload protection apparatus 20
Switching element 22
Conductive connection 24
Current-carrying element 26
Actuator apparatus 28
Separating element 30
Fusible element 32
End region 34
Base element 36
Extension 36′
Standard soldered joint 38
Spring element 40
Other current-carrying element 42
Edge 44
Arrows 46

1. A thermal overload protection apparatus for protecting an electrical component, in particular an electronic component, which thermal overload protection apparatus has a switching element for short-circuiting connections of the component or for isolating an electrically conductive connection between at least one of the connections and a current-carrying element of the overload protection apparatus, an actuator apparatus for displacing the switching element into a corresponding short-circuiting position or isolating position, and a tripping element which thermosensitively trips the actuator apparatus and is formed as a separating element,
characterized by
a base element to which the separating element is connected, wherein the base element can be soldered by means of a standard solder joint on a side of the base element, which side faces away from the separating element.

2. The overload protection apparatus according to claim 1, wherein the separating element is formed as a fusible element which trips by melting.

3. The overload protection apparatus according to claim 1, wherein the fusible element, which trips by melting, has a melting point that is lower than that of the solder of the standard soldered joint.

4. The overload protection apparatus according to claim 1, wherein the base element is mechanically connected to the switching element via the non-tripped separating element.

5. The overload protection apparatus according to claim 4, wherein the base element is electrically conductive and is also connected in an electrically conductive manner to the switching element via the non-tripped separating element.

6. The overload protection apparatus according to claim 1, wherein the actuator apparatus, for its activation from an inactive state in which the switching element cannot be displaced by the actuator apparatus, not even by tripping by means of the separating element, can be switched over into a tripable state in which the switching element can be displaced by the actuator apparatus.

7. The overload protection apparatus according to claim 1, wherein the actuator apparatus has at least one spring element, in particular, is a spring element.

8. The overload protection apparatus according to claim 7, wherein the spring element is a snap dome.

9. The overload protection apparatus according to claim 1, wherein the actuator apparatus, in the tripable state, is an actuator apparatus which is mechanically pretensioned at the switching element by means of a latching mechanism.

10. The overload protection apparatus according to claim 1, wherein said overload protection apparatus can be separated from the component.

11. An arrangement comprising a conductor track carrier, at least one component arranged thereon, and at least one overload protection apparatus according to claim 1, wherein the base element is soldered by means of a standard soldered joint to a conductor track of the conductor track carrier, which conductor track is directly connected to a connection of the component.

12. The arrangement according to claim 11, wherein the switching element and/or the actuator apparatus of the overload protection apparatus are directly supported on at least one of the conductor tracks.

13. A method for producing a tripping composite for a thermal overload protection apparatus according to claim 1, wherein the composite consists of a switching element, a base element for soldering the composite, and a separating element which is arranged between the switching element and the base element and connects them, and which is formed as a fusible element, characterized by the following steps:
providing the switching element with an extension of the one end region,
folding the extension next to the end region,
introducing the fusible element between the end region and the extension, and
removing the edge created during folding, wherein the remaining portion of the extension forms the base element.

14. The method according to claim 13, wherein the extension or the base element is formed in a trough-shaped manner.
